(19) United States
(12) Patent Application Publication
(10) Pub. No.: US 2024/0280719 A1
(43) Pub. Date: Aug. 22, 2024

(54) SYSTEMS AND METHODS FOR DETECTING SHIMMER DEVICES

(71) Applicants: University of North Texas, Denton, TX (US); BlackSwan CyberSecurity, LLC, Dallas, TX (US); Guardian Payment Solutions Corp., Georgetown, TX (US)

(72) Inventors: Len DENTON, Georgetown, TX (US); Michael SAYLOR, Richardson, TX (US); Scott H. BELSHAW, Denton, TX (US); Renee BRYCE, Denton, TX (US)

(21) Appl. No.: 18/570,969

(22) PCT Filed: Jun. 15, 2022
(86) PCT No.: PCT/IB2022/055551

§ 371 Date: Dec. 15, 2023

Related U.S. Application Data
(60) Provisional application No. 63/211,088, filed on Jun. 16, 2021.
(60) Provisional application No. 63/303,009, filed on Jan. 25, 2022.

(51) Int. Cl. G01V 3/02; G06Q 20/40

(52) U.S. Cl. CPC G01V 3/02; G06Q 20/4016

(57) ABSTRACT

The present disclosure relates to systems and methods for detecting the presence of a shimming device within a Europay, Mastercard and Visa (EMV) card reader. In aspects, a shimmer detection device is configured to detect characteristics that may be used to detect the presence of a shimmer within a card reader. In aspects, the shimmer detection device includes one or more sensors configured to collect data that is compared to reference sensor data to detect the presence of a shimmer within the card reader. An output is presented that indicates whether a shimmer is not present, likely present (e.g., the consumer or user should assume the scanned device contains a shimmer), or confirmed to be present. Such capabilities may enable user to test a device (e.g., a point of sale (POS) reader, an ATM, a fuel pump, etc.) to determine whether a shimmer is present and take mitigating action.

### CROSS-REFERENCE TO RELATED APPLICATIONS

The present application claims priority to U.S. Provisional Application No. 63/211,088 filed Jun. 16, 2021 and entitled “EAGLE SHIMMER DETECTOR,” and to U.S. Provisional Application No. 63/303,009 filed Jan. 25, 2022 and entitled “EAGLE SHIMMER DETECTOR,” the disclosures of which are incorporated by reference herein in their entirety.

### TECHNICAL FIELD

The present invention relates generally to technologies for mitigating risk of data theft and more specifically, to devices for detecting shimming devices configured to facilitate theft of financial card data.

### BACKGROUND OF THE INVENTION

Financial cards (e.g., credit cards, charge cards, and/or debit cards) are a very convenient feature of daily life. However, as these financial cards carry precious financial information, they have become a target of bad actors' efforts to steal such information. Bad actors have devised ways and have built devices for stealing or illegally collecting the information related to financial cards. One such device for stealing financial card information is a skimming device, which is configured to be placed within or over existing devices that consumers frequently utilize to facilitate financial card purchases. The skimming device is configured to read the information from the magnetic strip of financial cards, and to then provide it to the bad actors.

Even as financial cards have been redesigned to include more security features, so have efforts from bad actors to find ways to steal the information from these financial cards. For example, financial cards now include a Europay, Mastercard, and Visa (EMV) chip, which provides higher transaction security when the financial card is used. An EMV chip card may be inserted into a slot of a card reader, and the chip may make contact with a chip reader within the card reader. Now, however, shimming devices (or shimmers) are used to steal information from financial cards using an EMV chip. Shimmers are attachable devices that are inserted into EMV credit card readers to steal (or skim) information off of the cards' EMV chips instead of magnetic stripes as with typical card skimmers. These shimming devices are very small devices that are inserted and installed within chip readers (which makes them impossible to notice when they are installed) and are used to make contact with the financial card EMV chip and to steal the information from the EMV chip (e.g., financial card number, expiration date, personal identification number (PIN) data, etc.). The stolen information may be stored locally on the device where it may be retrieved at a later time by the perpetrator, or it may be transmitted wirelessly via Bluetooth or another communication protocol to the perpetrator, such as by retrieving data captured by a shimming device installed at a fuel pump using a laptop computing device.

### BRIEF SUMMARY OF THE INVENTION

The present application relates to systems, methods, and computer-readable storage media configured to detect the presence of shimming devices. In embodiments, a shimmer detection device may be configured with a plurality of sensors configured to detect characteristics that may be used to detect the presence of a shimmer. For example, shimmers may be installed within or onto other devices, such as within a chip reader at a point of sale (POS). In embodiments, the shimmer detection device may be configured to collect sensor data (e.g., via the plurality of sensors) and the collected sensor data may be used to detect the presence of a shimmer. In some embodiments, the collected sensor data may be compared to reference (or baseline) sensor data (e.g., data that is indicative of the presence of a shimmer) to detect the presence of the shimmer. In some embodiments, the sensor data collected by the plurality of sensors may include data related to the presence of components typically used in a shimming device, and which may serve to indicate the presence of the shimming device. For example, a shimmer detection device may collect data related to the presence of a particular radio device, such as a radio device that emits radio frequency (RF) at a particular frequency or range of frequencies, Bluetooth low energy (BLE) components, Zigby components, other wireless communication transmitters, etc. In these embodiments, detecting the presence of a component or device capable of particular wireless communications may serve to detect the presence of a shimmer, such as by facilitating the differentiation of a standard chip reader (e.g., a chip reader that has not been compromised by a shimmer, also referred to herein as a shimmerless chip reader) from a compromised chip reader (e.g., a chip reader into which a shimmer has been inserted).

In some embodiments, the shimmer detection device may be configured to facilitate the detection of a shimmer within a chip reader. For example, the shimmer detection device may include a card sleeve configured with, or one of the sides of the shimmer detection device may be configured with, at least one contact slot through which a blade read head of a chip reader may pass through to make contact with a connection point of the shimmer detection device. A failure to detect a contact between the connection point of the shimmer detection device and the blade read heads of a chip reader may indicate that the chip reader has been compromised by a shimmer, because a shimmer is typically configured with flat connectors that make contact with the blade read heads of the chip reader but prevent the blade read heads of the chip to pass through.

In embodiments, shimmer detection devices configured according to embodiments of the present disclosure may be configured to generate outputs that indicate whether a shimming device is not present, likely present (e.g., the consumer or user should assume the scanned device contains a shimmer or has otherwise been compromised), or confirmed to be present. Such capabilities may enable the user (e.g., a customer, a business operator, law enforcement, etc.) to quickly scan a device (e.g., an ATM, a fuel pump, etc.) to determine whether a shimming device is present and take action to mitigate the use of any detected shimming devices as well as prevent the perpetrator (e.g., the entity that provided the shimming device) from retrieving any financial card data that has already been captured by the shimming device.

In embodiments, a shimming detection device configured according to the present disclosure may include one or more light sources and light sensors for use in detecting shimming devices. The light source(s) may be configured to emit light as an output and the light sensor(s) may be configured to detect the emitted light. The light detected by the light sensors may be different when a shimming device is present as compared to when the shimming device is not present. This may enable shimming detection devices to be produced at low cost and provide an effective technique for detecting shimming devices. The shimming detection device may be a standalone device that may be inserted into a card reader device to scan for shimming devices. Additionally or alternatively, the shimming detection device may be integrated into a card reader device to scan for shimming devices.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram illustrating a shimmer detection device configured to detect shimming devices in accordance with an embodiment of the present disclosure;

FIG. 2 shows an example of a form factor of a shimmer detection device in accordance with embodiments of the present disclosure;

FIG. 3 is a diagram illustrating an example of contact slots configured to facilitate detection of a shimmer within a Europay, Mastercard, and Visa (EMV) card reader in accordance with aspects of the present disclosure;

FIGS. 4A-4C illustrate an example of normal operations of an EMV card reader;

FIGS. 5A-5C illustrate an example of shimmer detection operations using contact slots in accordance with aspects of the present disclosure;

FIG. 6 illustrates a flow diagram of a method of detecting a shimming device in accordance with an embodiment of the present disclosure;

FIG. 7 is a block diagram of a financial card reader device;

FIG. 8 is a block diagram of a financial card reader device having a shimming device;

FIG. 9 is another block diagram of a financial card reader device having a shimming device;

FIG. 10A is a block diagram illustrating a top view of a shimming detection device in accordance with aspects of the present disclosure;

FIG. 10B is a block diagram illustrating a side view of a shimming detection device in accordance with aspects of the present disclosure;

FIG. 11 is a block diagram illustrating a side view of a shimming detection device in accordance with aspects of the present disclosure;

FIG. 12 is a block diagram illustrating a system for detecting a shimming device in accordance with aspects of the present disclosure;

FIG. 13 is a block diagram illustrating a system for detecting a shimming device in accordance with aspects of the present disclosure;

FIG. 14 is a block diagram illustrating a system for detecting a shimming device in accordance with aspects of the present disclosure; and

FIG. 15 is a flow diagram of a method for detecting a shimming device in accordance with aspects of the present disclosure.

The Appendix provides further details regarding various aspects of this disclosure and the subject matter therein forms a part of the specification of this application.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE INVENTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

As noted above, shimmers are illicit devices that are inserted into a Europay, Mastercard and Visa (EMV) credit card reader to illegally capture or steal information from the cards' EMV chips. The shimmer may be inserted into a slot of the EMV card reader and may be attached to the inside of the EMV card reader (e.g., may attach onto the EMV chip reader of the EMV card reader). Shimmers are very small devices and once inserted and installed within an EMV card reader, the shimmer may be virtually impossible to detect via visual inspection. Various embodiments of the present disclosure provide a shimmer detection device configured to detect the presence of a shimmer within an EMV card reader.

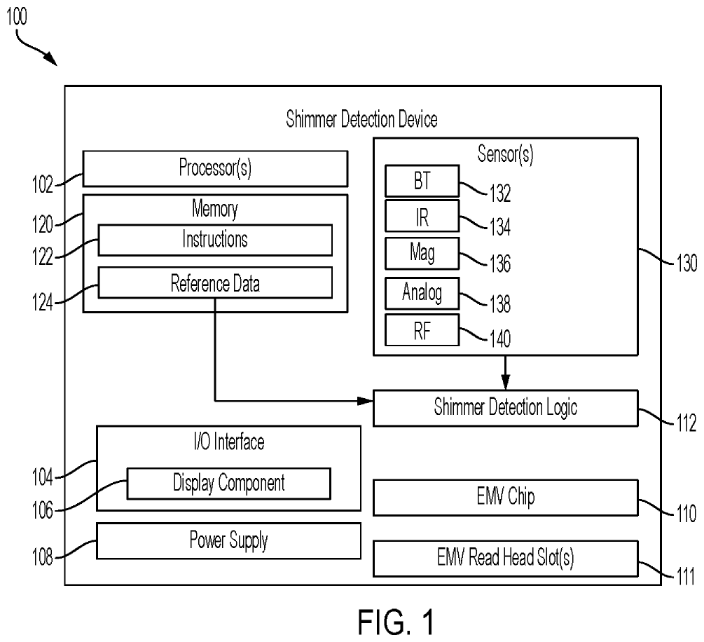

FIG. 1 is a block diagram illustrating a shimmer detection device configured to detect shimming devices in accordance with an embodiment of the present disclosure. As shown in FIG. 1, the shimmer detection device 100 includes one or more processors 102, memory 120, input/output (I/O) interface 104, a display component 106, a power supply 108, EMV chip 110, at least one EMV read head slot 111 (also referred to as “contact slots” herein), shimmer detection logic 112, and one or more sensors 130. These components, and their individual components, discussed in more detailed below, may cooperatively operate to provide functionality in accordance with the discussion herein. In aspects, shimmer detection device 100 may have a form factor that simulates a typical card that is to be inserted into an EMV card reader's slot. In aspects, at least a portion of shimmer detection device 100 may be configured to have a thickness configured to be inserted into the EMV card reader's slot being tested. In some aspects, the thickness of at least a portion of shimmer detection device 100 may be configured to fit tightly when inserted into the EMV card reader's slot, such that the at least a portion of shimmer detection device 100 may be inserted into the EMV card reader's slot when no shimmer is present within the EMV card reader, but may be prevented, at least partially, from being inserted into the EMV card reader's slot when a shimmer is present within the EMV card reader's slot as there is little or no space tolerance between the thickness of the at least a portion of the shimmer detection device 100 and the slot of the EMV card reader.

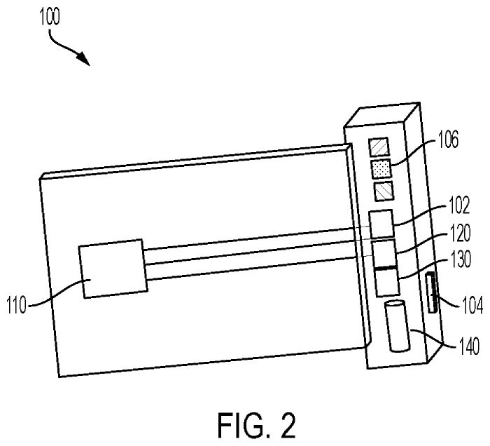

FIG. 2 shows an example of a form factor of shimmer detection device 100 in accordance with embodiments of the present disclosure. As shown, shimmer detection device 100 has a form factor that simulates a typical debit or credit card, at least partially. Shimmer detection device 100 has a particular thickness, as described above, and may include a portion that contains the various components of shimmer detection device 100 as described herein.

With reference back to FIG. 1, it is noted that various components of shimmer detection device 100 are illustrated as single and separate components in FIG. 1. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that the functional blocks, and components thereof, of shimmer detection device 100 of embodiments of the present invention may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally or alternatively, when implemented in software, one or more of the functional blocks, or some portion thereof, may comprise code segments operable upon a processor to provide logic for preforming the functions described herein.

One or more sensors 130 may include sensors configured to detect, capture, measure, read, and/or otherwise obtain information and/or signals to produce captured sensor data. The captured sensor data may be used by shimmer detection device 100 (e.g., using shimmer detection logic 112, along with reference data 124 in some embodiments) to determine whether a shimming device is present within an area under analysis, as described in more detail below. In embodiments, one or more sensors 130 may include at least one Bluetooth sensor 132, at least one infrared sensor 134, at least one magnetometer 136, at least one analog sensor 138, and/or at least one radio frequency (RF) transceiver 140. It is noted that FIG. 1 illustrates the one or more sensors 130 as including five sensors for purposes of illustration, rather than by way of limitation and that embodiments of a shimmer detection device may include more than five sensors or less than five sensors depending on the particular configuration of the shimmer detection device. Additionally, although the sensors are described and illustrated as including Bluetooth sensors, infrared sensors, magnetometer sensors, analog sensors, and RF transceivers, embodiments are not limited to these specific sensors and may use other types of sensors that may provide information relevant to detecting the presence of shimming devices. For example, the one or more sensors 130 may additionally include Wi-Fi sensors configured to detect signals associated with Wi-Fi emanating from components of a shimming device.

In embodiments, Bluetooth sensor 132 may be configured to detect emanations associated with a Bluetooth transmission. For example, in embodiments, Bluetooth sensor 132 may detect Bluetooth signals (e.g., RF transmissions at 2.4 GHz, which are typically associated with Bluetooth transmissions) emanating from an EMV card reader being tested. In aspects, Bluetooth sensor 132 may include a Bluetooth transceiver (e.g., an ESP32 microcontroller) operating in cooperation with a Bluetooth Low Energy (BLE) interface. The cooperative operation of these components may provide functionality for identifying a shimming device operating to transmit over Bluetooth. In some embodiments, Bluetooth sensor 132 may be configured to detect a Bluetooth transmission from a shimming device within an EMV card reader, and may also detect the shimming device's Bluetooth component ID. In embodiments, the Bluetooth component ID may be used to tag or track a shimming device found in an EMV card reader. In this manner, law enforcement agencies may be able to tie a found shimming device to a particular perpetrator, such as by tying the Bluetooth component ID of the shimming device to a cell phone, laptop, or other devices used by the perpetrator to receive the stolen information from the shimming device.

In embodiments, RF transceiver 140 may include a radio (e.g., a software defined radio (SDR)) configured to receive and/or detect signals within a particular range of RF frequencies. For example, RF transceiver 140 may include a radio transceiver configured to operate within a frequency range that includes 2.4 GHz (e.g., a frequency typically associated with Bluetooth transmissions). In some embodiments, RF transceiver 140 may be configured to intercept signals within the operations frequency range. In this manner, RF transceiver 140 may detect RF frequency transmissions from within the EMV card reader being tested. In some embodiments, RF transceiver 140 may include an RF reader configured to read and write from the shimmer within a compromised EMV card reader. For example, an RF system (e.g., an RF identification (RFID) system) may be configured to read and write to an RF device (e.g., a shimming device). Upon the shimming device accepting a write function, penetration techniques may be used to compromise the shimming device (e.g., using tools and payloads stored in memory 120 or in an external memory device (e.g., a universal serial bus (USB) device attached to shimmer detection device 100)) in order to read the information stored within the shimming device.

In embodiments, analog sensor 138 may be configured to detect and/or measure a current and/or resistance associated with an EMV card reader. For example, shimmer detection device 100 may be inserted into an EMV card reader being tested. Analog sensor 138 may be configured to measure a resistance (e.g., using an ammeter) after shimmer detection device 100 is inserted into the EMV card reader being tested. In some embodiments, shimmer detection device 100 may be configured to measure a change in resistance (e.g., using an ammeter) when shimmer detection device 100 is inserted into the EMV card reader being tested. The measured resistance, or change in resistance, may then be compared to a reference current and/or resistance profile, which may indicate whether a shimmer may be present within the EMV card reader being tested. In embodiments, when shimmer detection device 100 is used to test a shimmerless EMV card reader, measuring normal with a voltage regulator embedded within shimmer detection device 100, and connecting V+ and V− of the voltage regulator with the Vcc and GND pins of EMV chip 110 of shimmer detection device 100, respectively, to match the voltage of the EMV chip reader of the EMV card reader being tested, no current flow is detected, as the Vcc contact points share the same potential. However, when some unknown device (e.g., a shimming device) is placed between the EMV chip reader of the EMV card reader and the shimmer detection device, and shimmer detection device 100 is inserted into the EMV card reader, a parallel circuit is formed, and current will flow into the unknown circuit, which may be detected using an ammeter of analog sensor 138.

In embodiments, infrared sensor 134 may be configured to detect and/or measure infrared emanations from a EMV card reader being tested. Using the infrared energy detected infrared sensor 134, shimmer detection device 100 may create a heat map of the EMV card reader being tested, and the heat map may be used to identify components and/or devices that are indicative of the presence of a shimmer (e.g., the heat map may show a battery where a battery is not configured for the EMV card reader, but may be used by a shimmer). Magnetic sensor 136 may be configured to detect magnetic signals. The magnetic signals may be used to create a magnetic profiles of a known compromised EMV reader, and the magnetic profile may be used to determine the presence of a shimmer within an EMV card reader, such as when the magnetic profile of the EMV card reader matches the magnetic profile of the known compromised EMV card reader.

Processor 102 may comprise a processor, a microprocessor, a controller, a microcontroller, a plurality of microprocessors, an application-specific integrated circuit (ASIC), an application-specific standard product (ASSP), or any combination thereof, and may be configured to execute instructions 122 to perform operations of shimmer detection device 100 in accordance with the disclosure herein. In some aspects, as noted above, implementations of processor 102 may comprise code segments (e.g., software, firmware, and/or hardware logic) executable in hardware, such as a processor, to perform the tasks and functions described herein. In yet other aspects, processor 102 may be implemented as a combination of hardware and software. Processor 102 may be communicatively coupled to memory 120.

Memory 120 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 120 may comprise a processor readable medium configured to store one or more instruction sets (e.g., software, firmware, etc.) which, when executed by a processor (e.g., one or more processors of processor 102), perform tasks and functions as described herein. For example, memory 120 may include instructions 122.

In embodiments, memory 120 may be configured to store reference data 124. Reference data 124 may correspond to data that may be indicative of the presence, or likely presence, or absence or likely absence, of a shimmer within an EMV card reader. In some embodiments, reference data 124 may include signatures generated based on sensor data detected from known shimming devices. For example, sensor data detected by sensors (e.g., one or more sensors 130) from known shimming devices may be used to generate a signature indicative of the presence of a shimming device. During operation, reference data 124 may be compared against sensor data collected using at least one sensor 130 to determine and/or detect whether a shimmer is present within an EMV card reader. In embodiments, reference data 124 may include radio frequency signatures associated with known shimming devices, infrared signatures associated with known shimming devices, magnetic signatures of known shimming devices, reference current and/or resistance profiles, other types of signatures, etc. The reference data 124 may comprise a library of signatures associated with signatures of shimming device components (e.g., memory, processors, and the like). The memory 120 may additionally be configured to store sensor data captured by the one or more sensors 130 during operation of the shimmer detection device 100, as described in more detail below.

In embodiments, the radio frequency signatures included in reference data 124 may include Bluetooth frequencies (e.g., 2.4 GHz or a frequency range that includes 2.4 GHz). In these embodiments, a detection (e.g., using one or more sensors 130) may be indicative of the presence of a shimmer within the EMV card reader. In some embodiments, the reference current and/or resistance profiles included in reference data 124 may include current and/or resistance profiles of known EMV card readers, which may be used to determine whether a shimmer may be present within the EMV card reader. In these cases, an ammeter (e.g., as part of sensor(s) 130) may be used by shimmer detection device 100 to detect a change in resistance when shimmer detection device 100 inserted into the EMV card reader. Shimmer detection device 100 may determine that a shimmer is present within the EMV card reader when the resistance measured after insertion of shimmer detection device into EMV card reader 100 is different than the expected resistance value. In some embodiments, the expected resistance value may be a resistance value known to be a resistance value of a shimmerless EMV card reader, or may be a resistance value previously baselined for the EMV card reader being tested. In some embodiments, the expected resistance value may be a resistance value compared with other EMV card readers at the location of the EMV card reader being tested.

In embodiments, reference data 124 may include signatures generated based on sensor data detected from known shimmerless devices. For example, shimmer detection device 100 may be deployed within an EMV card reader known to be shimmerless. Sensor data captured by at least one sensor 130 may be used to generate a signature and may be stored as reference data 124. During operation, shimmer detection device 100 may capture data using at least one sensor 130, and the captured data may be compared against the signatures of known shimmerless EMV card readers. When the captured data matches the signature of a known shimmerless EMV card reader, the EMV card reader may be determined to be shimmerless. When the captured data does not match the signature of a known shimmerless EMV card reader, a shimmer may be determined to be present within the EMV card reader.

In embodiments, shimmer detection logic 112 may be configured to determine, based on the captured sensor data from one or more sensors 130 and/or based on reference data 124, at least in part, whether a shimming device is present, likely present, absent, or likely absent, from an area being tested, or within an EMV card reader being tested. In embodiments, shimmer detection logic 112 may determine whether a shimming device is present based on execution of at least a portion of instructions 122 stored within memory 120. In embodiments, shimmer detection logic 112 may determine that a shimming device is present, or at least likely present, within an EMV card reader, based on a determination that the captured sensor data indicates that an shimming device is present, or likely present. For example, shimmer detection logic 112 may compare the captured sensor data to a shimmer signature included in reference data 124. In this case, the shimmer signature may include sensor data captured for a compromised EMV card reader with a shimmer installed within it. Shimmer detection logic 112 may determine that the captured sensor data matches the shimmer signature, in which case shimmer detection logic 112 may determine that the EMV card reader being tested is compromised and/or that a shimmer is present within the EMV chip reader being tested.

In embodiments, shimmer detection logic 112 may determine that a shimming device is absent, or at least likely absent, within an EMV card reader, when the captured sensor data does not match the shimmer signature. In additional or alternative embodiments, shimmer detection logic 112 may determine that a shimming device is absent, or at least likely absent, within an EMV card reader, when the captured sensor data matches a signature associated with a shimmerless EMV card reader. For example, shimmer detection logic 112 may compare the captured sensor data to a reference signature included in reference data 124. In this case, the reference signature may include sensor data captured for a shimmerless EMV card reader (e.g., another EMV card reader known to be shimmerless, or a previously measured baseline of the EMV card reader being tested). Shimmer detection logic 112 may determine that the captured sensor data matches the reference signature, in which case shimmer detection logic 112 may determine that the EMV card reader being tested is not compromised and shimmerless.

In embodiments, shimmer detection logic 112 may be configured to detect a level of matching of the captured data to the reference data 124. For example, comparing captured data to reference data 124 may yield a result with a percentage of matching between the captured data and reference data 124. In these cases, shimmer detection logic 112 may determine a likelihood that an EMV card reader is compromised with a shimmer based on the level of matching. In this case, if the matching between the captured data and reference data 124 is not above a predetermined first threshold, shimmer detection logic 112 may determine that a shimming device is not present within the EMV card reader. However, if the matching between the captured data and reference data 124 is above the predetermined first threshold, shimmer detection logic 112 may determine that a shimming device is present within the EMV card reader. In some embodiments, if the matching between the captured data and reference data 124 is above the predetermined first threshold, but not below a second threshold, shimmer detection logic 112 may determine that a shimming device is “likely” present within the EMV card reader. However, if the matching between the captured data and reference data 124 is above the predetermined first threshold, and above the second threshold, shimmer detection logic 112 may determine that a shimming device is “confirmed” to be present within the EMV card reader.

EMV chip 110 may be configured to interface with the EMV chip reader of an EMV card reader (or the shimmer when a shimmer is installed within the EMV card reader) in order to facilitate detection of a shimmer. For example, in some embodiments, EMV chip 110 may operate in cooperation with analog sensor 140 to measure and/or detect a current and/or resistance when a shimmer detection device is present in the EMV chip reader being tested. In these cases, EMV chip 110 may contact the shimmer in order to provide the connections for performing the measurements as described above. In embodiments, EMV chip 110 may be configured as a typical EMV chip, and or may be simulated to operate as a typical EMV chip.

I/O interface 104 may include various devices and/or components configured to receive inputs, such as a mouse, a keyboard, one or more buttons (e.g., a button to initiate sensing operations to detect a shimming device), one or more switches (e.g., a power switch to turn shimmer detection device 100 off/on), communication interfaces (e.g., universal serial bus (USB) ports, serial ports, etc.), network communication interfaces (e.g., devices that enable shimmer detection device 100 to communicate over one or more networks), a touchpad, etc.

In embodiments, communication interfaces of I/O interface 104 may include wireless communication interfaces, such as Wi-Fi and/or Bluetooth, and or wired communication interfaces, such as Ethernet, etc. Shimmer detection device 100 may communicate or connect over these communication interfaces with other devices or user terminals, such as a personal computer, a laptop, a mobile device, a tablet, a cellular device, a cell phone, servers, etc. For example, shimmer detection device 100 may communicate with a user terminal via Wi-Fi or Bluetooth. In embodiments, shimmer detection device 100 may be configured to, via the communication interfaces of I/O interface 104, connect to an application running on a user terminal (e.g., a cell phone), or a server, to perform various operations. For example, shimmer detection device 100 may receive, via the application, downloads, such as reference sensor data (e.g., reference data 124) that may be used to determine whether a shimmer is present within an EMV card reader. In some embodiments, the application may be configured to connect to an external online library of baseline measurements and settings (e.g., based on an EMV card reader make and model being tested by shimmer detection device 100) to obtain data (e.g., reference data) for determining whether an EMV card reader is compromised, and then passing the information to shimmer detection device 100. In some aspects, this access to external online libraries may be performed dynamically and/or real-time during operations of shimmer detection device 100. In embodiments, shimmer detection device 100 may also receive, from the application running on a user terminal, software updates, detection logic updates, etc. The application may also allow automated, or user-initiated, collection and archiving of daily inspections. In some embodiments, shimmer detection device 100 may offload processing of data (e.g., captured sensor data) to the application hosted in the user terminal to determine whether a shimmer is present within an EMV card reader. In this manner, computing processing power of shimmer detection device 100 may be conserved, as the process is offloaded to the process of the user terminal (e.g., cell phone).

I/O interface 104 may include display component 106 configured to provide feedback associated with the shimmer detecting operations of shimmer detection device 100. In some embodiments, display component 106 may include at least three indicators of different colors, each of which may indicate one of: that a shimmer device is not present, that a shimmer device is likely present, or that a shimmer device is confirmed to be present. In embodiments, display component 106 may include a graphical user interface (GUI) structured to facilitate input and output operations in accordance with aspects of the present disclosure. Information associated with information feedback of the one or more sensors may be displayed within display component 106. For example, component device 106 may be configured to show an outline of one or more batteries detected within an EMV card reader device as detected by the IR sensor 134. As another example, certain Bluetooth signals may indicate a possible shimmer device may be present as discussed above (e.g., if a Bluetooth signal is present that is not associated with a device operated by the proprietor of the location where the signal was detected and persists for a period of time). It is noted that the specific examples described above for detecting the presence of a possible shimming device have been provided for purposes of illustration, rather than by way of limitation and that shimmer detection devices operating in accordance with embodiments of the present disclosure may utilize other types of sensor data and sensor data characteristics to detect the presence of a shimming device.

Power supply 108 may be configured to provide operational power to the shimmer detection device 100, and/or any of the components of shimmer detection device 100, such as by supplying power to the shimmer detection device 100 from one or more batteries.

During operation of shimmer detection device 100, a user may interact with I/O interface 104 to initiate shimmer sensing operations. For example, the user may toggle a power switch to turn shimmer detection device 100 on. Once powered on, the user may interact with the shimmer detection device to provide an input to initiate operations to detect whether any shimming devices are present within an EMV card reader. In some embodiments, the shimmer detection device may be inserted into a card sleeve configured in accordance with aspects of the present disclosure. In some embodiments, the user may initiate operations to detect whether a shimming device is present within an EMV card reader by inserting the shimmer detection device into the EMV card reader. In response to the input received or in response to the shimmer detection device being inserted into the EMV card reader, the one or more processors 102 may activate the one or more sensors 130. Once activated, the one or more sensors 130 may begin detecting characteristics of the EMV card reader, such as detecting the presence of one or more Bluetooth enabled devices (which may represent a potential shimmer device within the EMV card reader, detecting heat signatures (e.g., of one or more batteries of a potential shimming device), detecting RF signals, detecting analog current and/or resistance profiles of the EMV card reader, detecting whether a contact has been detected between the EMV chip of the shimmer detection device and the EMV chip reader, etc. As the one or more sensors 130 perform sensing operations, sensor data may be generated and stored as captured sensor data, and/or may be displayed such as using display component 106.

The one or more processors 102 may analyze, or may cause a component (e.g., shimmer detection logic 112) to analyze the captured sensor data to determine whether a shimmer device is present within the EMV card reader. As described above, tone or more processors 102 may determine whether a shimmer device is present within the EMV card reader by comparing the captured sensor data to reference data 124 to determine whether the captured sensor data indicates the presence of a shimming device. For example, if information received from Bluetooth sensor 132 matches a shimmer signature of a Bluetooth device known to be used in shimming devices, one or more processors 102 may detect that a possible shimming device is present. In another example, if the resistance and/or current measured by analog sensor 138 is different than the resistance and/or current expected of a shimmerless EMV card reader, one or more processors 102 may detect that a possible shimming device is present. In yet another example, if no contact is detected between the EMV chip of the shimmer detection device and the EMV chip reader of the EMV card reader, one or more processors 102 may detect that a possible shimming device is present.

After analyzing the captured sensor data in comparison to reference data 124, the shimmer detection device 100 may generate an output that indicates whether a shimming device is present. The output may be displayed using display component 106 and may include information that indicates a classification of a shimming device. For example, having detected a possible shimming device, shimmer detection device 100 may determine a classification of the shimming device. The classification may indicate a confidence level regarding the presence of the shimming device. For example, a first confidence level may indicate a shimming device is not present, a second confidence interval may indicate a shimming device is possibly or likely present, and a third confidence level may indicate that a shimming device is definitely present. The information that indicates the classification of the shimming device may include a color coded indicator, where different colors of the color coded indicator correspond to different classifications of the shimming device (e.g., green means no shimming device is present, yellow means a shimming device is possibly present, and red means a shimming device is definitely present). It is noted that other forms of indication, such as text, numeric indicators, sound indicators, and the like may be used to provide the output or supplement the output with additional information. If a shimming device is detected as being possibly present or confirmed present, the user may forgo conducting a transaction at the scanned device (e.g., if the user is a consumer) or may examine the scanned device to locate and remove the shimming device and/or confirm whether a shimming device is present.

As shown above, shimmer detection devices configured in accordance with embodiments of the present disclosure facilitate robust detection of shimming devices, such as to detect shimming devices that utilize wireless communications (e.g., Bluetooth shimming devices) as well as shimming devices that may not utilize wireless communications (e.g., shimming devices that must be physically retrieved to obtain the captured data).

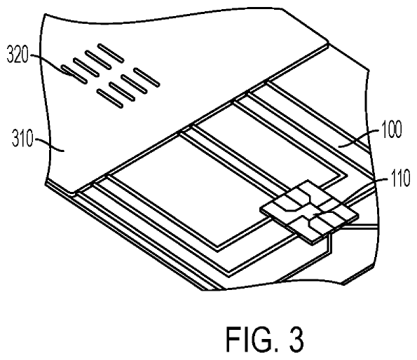

In some embodiments, a shimmer detection device implemented in accordance with embodiments of the present disclosure may be configured with at least one contact slot to facilitate detection of a shimmer within an EMV card reader. FIG. 3 is a diagram illustrating an example of contact slots configured to facilitate detection of a shimmer within an EMV card reader in accordance with aspects of the present disclosure. It is noted that the discussion that follows with respect to contact slots for facilitating detection of a shimmer within an EMV card reader focuses on embodiments where a card sleeve is used. However, this is for illustrative purposes only, not intended to be limiting in any way. For example, in some embodiments, the contact slots may be disposed onto the body or structure of shimmer detection device 100 itself, rather than on a sleeve into which shimmer detection device 100 slides. In these embodiments, the functionality and/or operations with respect to the contact slots may be similar to detect a shimmer.

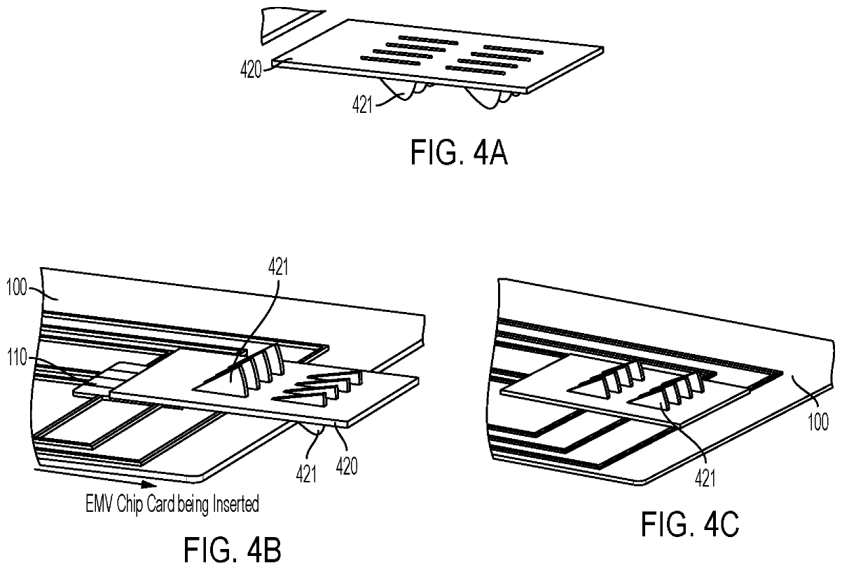

During normal operations of an EMV card reader, read head blades of the EMV chip reader of the EMV card reader make contact with the EMV chip of a card inserted into the EMV card reader. FIGS. 4A-4C illustrate an example of normal operations of an EMV card reader. As shown in FIG. 4A, EMV chip reader 420 includes at least one read head blade 421. Read head blades 421 may be configured to make contact with an EMV chip when a card is inserted into the EMV card reader and to serve as connections between the EMV chip and the EMV chip reader. Read head blades 421 may be spring tensioned such that, when a pushing force is applied, the read head blades recede onto the EMV chip reader, but return to the open position when the pushing force is removed. For example, as shown in FIG. 4B, shimmer detection device 100 may be inserted into the EMV chip reader (not shown) and as shimmer detection device 100 is slid underneath EMV chip reader 420 and makes contact with read head blades 421, read head blades 421 begin to be pushed upwards. As shown in FIG. 4C, when shimmer detection device 100 is fully inserted into the EMV card reader, EMV chip 110 of shimmer detection device 100 may be lined up with the EMV chip reader and the read head blades 421 may be pushed upwards and may make contact with the EMV chip 110.

With reference back to FIG. 3, card sleeve 310 may be configured to receive shimmer detection device 100. For example, card sleeve 310 may be provided as a sleeve that slides over shimmer detection device 100. In embodiments, card sleeve 310 may be configured with one or more contact slot(s) 320 configured to be disposed over EMV chip 110 when shimmer detection device 100 is inserted into card sleeve 310. Contact slot(s) 320 may be configured to allow the read head blades of the EMV chip reader to pass through and make contact with EMV chip 110. However, as will be shown below, when a shimmer is installed within the EMV card reader, the shimmer prevents the read heads of the EMV chip reader from passing through the shimmer. In this manner, when there is no contact detected between the EMV chip reader and the EMV chip of shimmer detection device 100, it may be determined that there may be a shimmer within the EMV card reader preventing the contact.

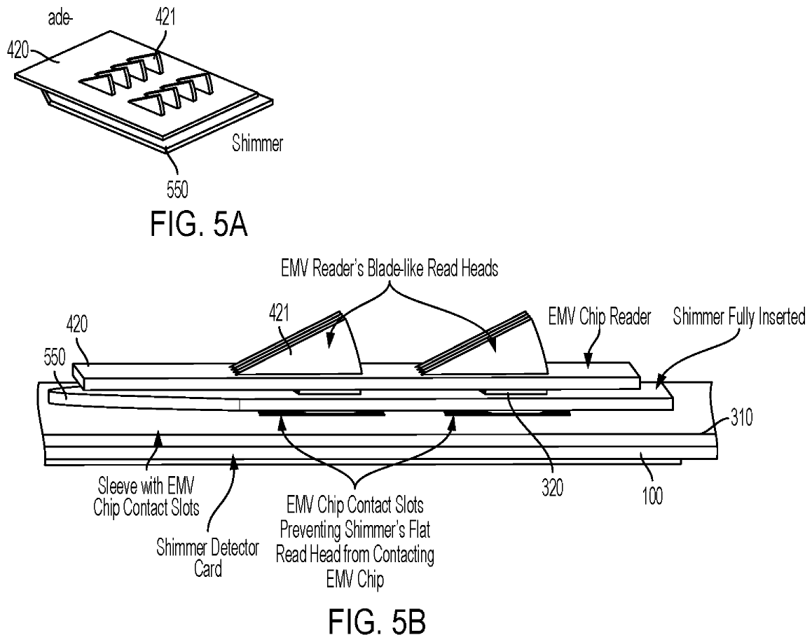

FIGS. 5A-5C illustrate an example of shimmer detection operations using contact slots in accordance with aspects of the present disclosure. As shown in FIG. 5A, when a shimmer (e.g., shimmer 550) is installed onto or attached to an EMV chip reader (e.g., EMV chip reader 420), read head blades 421 of the EMV chip reader 420 may be in the compressed or pushed position, as shimmer 550 typically has a flat body with solid contacts on both sides that do not allow read head blades 421 to pass through shimmer 550. For example, shimmer 550 may have contact on the upper side for contacting read head blades 421 of EMV chip reader 420, and may have solid flat contact on the lower side for contacting a card when the card is inserted into the EMV card reader. In this manner, when a shimmer is attached to or inserted within an EMV chip reader, the shimmer prevents the read head blades of the EMV chip reader from passing through the shimmer to contact an EMV chip of a card that may be inserted, while the shimmer maintains contact with both the EMV chip reader and the EMV chip of the inserted card. As discussed herein, the contact slot configuration described herein takes advantage of the shimmer configuration to detect whether a shimmer is present within an EMV card reader.

As shown in FIG. 5B, shimmer detection device 100 may be inserted into card sleeve 310 and the assembly may be inserted into the EMV card reader having EMV chip reader 420. In this example, EMV chip reader 420 may have shimmer 550 attached thereto. In this case, read head blades 421 may be compressed upwards and may make contact with the upper side of shimmer 550, but may not pass through shimmer 550 to make contact with EMV chip 110 of shimmer detection device 100 (e.g., may not pass through contact slot(s) 320). Moreover, the flat connectors on the bottom side of shimmer 550 may contact card sleeve 310, but may not contact EMV chip 110 of shimmer detection device 100. As no contact is detected with EMV chip 110 of shimmer detection device 100, shimmer detection device 100 may determine that a shimmer may be present within the EMV card reader. This determination is made in response to the determination that no contact between the EMV chip reader and the EMV chip of shimmer detection device 100 was detected, which may indicate that an unknown object may be preventing read head blades from deploying downwards and making contact with the EMV chip.

However, when contact is detected between the EMV chip reader and the EMV chip of shimmer detection device 100, a determination may be made that no shimmer is present within the EMV card reader. For example, as shown in FIG. 5C, when no shimmer is present and shimmer detection device 100 with card sleeve 310 is inserted into the EMV card reader, contact slot(s) 320 of card sleeve 310 may be lined up with read head blades 421, and read head blades 421 may be allowed to pass through contact slot(s) 320 to make contact with EMV chip 110 of shimmer detection device 100. As contact is detected between EMV chip 110 of shimmer detection device 100 and EMV chip reader 420, shimmer detection device 100 may determine that a shimmer may not be present within the EMV card reader. This determination is made in response to the determination that contact between the EMV chip reader and the EMV chip of shimmer detection device 100 was detected, which may indicate that there are no objects preventing read head blades from deploying downwards, passing through the contact slots of the card sleeve, and making contact with the EMV chip.

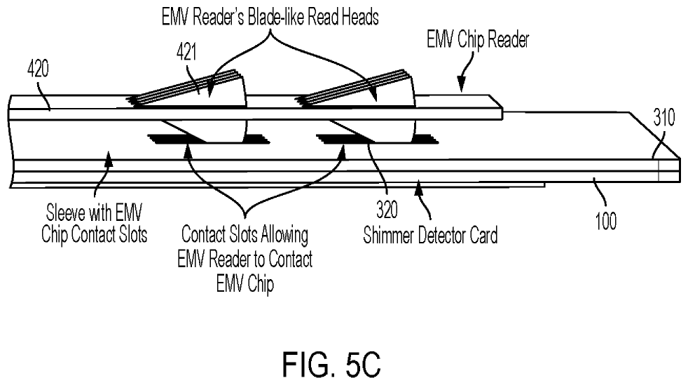

FIG. 6 illustrates a flow diagram of a method of detecting a shimming device in accordance with an embodiment of the present disclosure. As shown in FIG. 6, the method 600 includes, at step 602, capturing, by one or more sensors of a shimmer detection device, sensor data associated with a presence of the shimming device within a card reader in response to the shimmer detection device being inserted into the card reader. In aspects, the card reader may be an EMV card reader. As described above with reference to FIG. 1, the one or more sensors may include Bluetooth sensors, infrared sensors, magnetometers, RF transceivers, analog sensors, card sleeve, and/or a combination thereof. In some aspects, the one or more sensors may include a card sleeve, and the shimmer detection device may be inserted into the card sleeve prior to the shimmer detection device being inserted into the card reader.

At step 604, the method 600 includes comparing, by at least one processor of the shimmer detection device, the captured sensor data to reference data. In aspects, the reference data may include signature associated with sensor data captured from a card readers known to be compromised with a shimmer. As such, the reference data may include information associated with one or more signatures or characteristics of shimming devices (e.g., if the sensor data matches a signature in the reference data the sensor has likely detected a shimming device within the card reader). As another example, the reference data may include information indicating that the read head blades did not enter the slots of the sleeve, thereby indicating the presence of a shimmer. Additionally or alternatively, the reference data may include information associated with one or more signatures or characteristics indicative of the lack of a shimming device being present in the card reader. The card reader may include ATMs, fuel pumps, POS devices, or other devices that include a chip reader and present a possible device where a shimming device may be deployed.

At step 606, the method 600 includes determining, by the at least one processor, whether the captured sensor data includes information that indicates the presence of the shimming device within the card reader based on the comparing. In aspects, determining whether the captured sensor data includes information that indicates the presence of the shimming device within the card reader based on the comparing may include measuring, by the analog sensor of the one or more sensors, a resistance subsequent to the shimmer detection device being inserted into the card reader, or a resistance change upon the shimmer detection being inserted into the card reader. The measured resistance may then be compared to an expected resistance. The expected resistance may be a resistance that is expected to be measured by the analog sensor when the shimmer detection device is inserted into a shimmerless card reader. As another example, the expected resistance (i.e., reference data) may correspond to an expected resistance when a card reader has a shimmer device present. The shimmer detection device may determine that a shimming device is present within the card reader when the measured resistance is different from the expected resistance of a shimmerless card reader (e.g., when the reference data includes measured resistance data for a shimmerless card reader) or when the measured resistance is the same as the expected resistance of a shimmerless card reader (e.g., when the reference data includes measured resistance data for a card reader having a shimmer present). In some aspects, the shimmer detection device may determine that a shimming device is not present within the card reader when the measured resistance is the same as, substantially the same as, or within a threshold value from, the expected resistance (e.g., when the reference data includes measured resistance data for a shimmerless card reader). Additionally or alternatively, the shimmer detection device may determine that a shimming device is present within the card reader when the measured resistance is the same as, substantially the same as, or within a threshold value from, the expected resistance (e.g., when the reference data includes measured resistance data for a card reader having a shimmer present).

In some aspects, the one or more sensors may include the card sleeve. The card sleeve may be configured with at least one contact slot, and the at least one contact slot may be configured to allow at least one read head blade of the card reader to pass through when the at least contact slot is disposed under the at least one read head blade. In aspects, a determination may be made as to whether, subsequent to the shimmer detection device being inserted into a card reader, the at least one read head blade of the card reader is in communicative contact with the shimmer detection device. When the at least one read head blade of the card reader is determined to be communicatively disconnected from or not communicatively connected to an EMV chip of the shimmer detection device, the shimming device may be determined to be present within the card reader. When the at least one read head blade of the card reader is determined to be communicatively connected to the EMV chip of the shimmer detection device, the shimming device may be determined to not be present within the card reader.

At step 608, the method 600 includes generating, by the at least one processor, an output that indicates whether the shimming device is present. In aspects, a confidence level regarding the presence of the shimming device may be determined, and the output that indicates whether the shimming device is present may include the confidence level. The confidence level may be presented in the output as a color coded indicator including different colors that correspond to different confidence levels. In these aspects, the confidence level may indicate one of: a shimming device is not detected, a shimming device is likely detected, or a shimming device is confirmed detected.

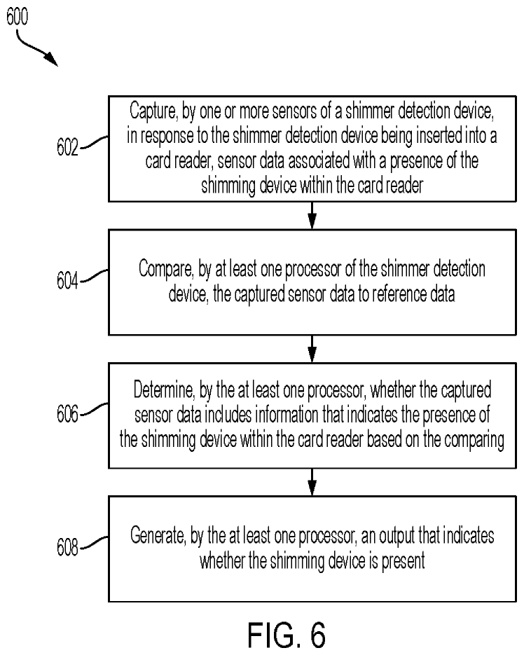

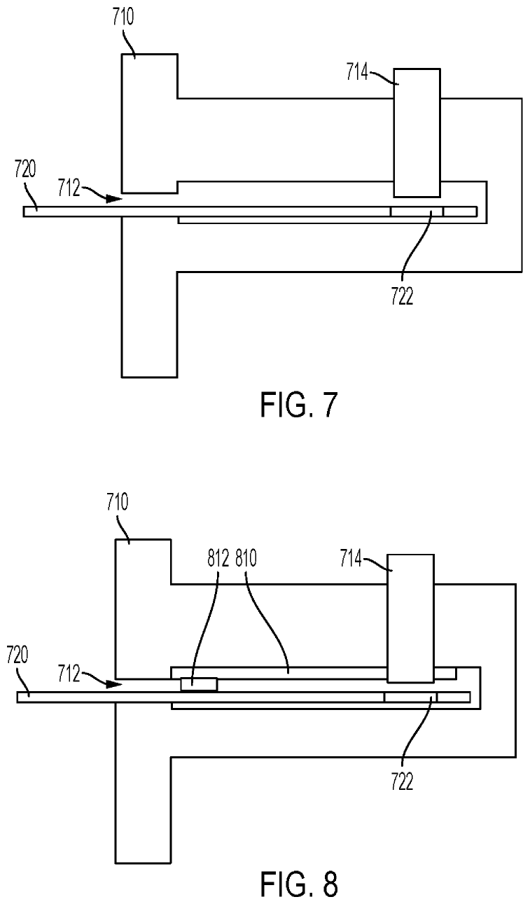

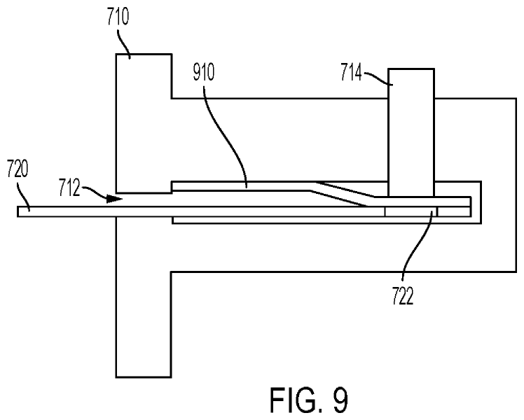

Referring to FIG. 7 is a block diagram of a card reader device is shown as a card reader device 710. As shown in FIG. 7, the card reader device 710 includes a slot 712 and an EVM chip reader 714. A financial card, such as a card 720 including an EVM chip 722, may be inserted into the slot 712 and the EVM chip reader 714 may read information from the card 720 via the EVM chip 722, as described above. FIG. 8 illustrates a block diagram of a card reader device having a shimming device installed. In particular, FIG. 8 shows the card reader device 710 and the card 720 of FIG. 7 having a shimming device 810 having a magnetic stripe reader 812. When the card 720 is inserted into the card reader 710 via the slot 712, the magnetic stripe reader 812 may read information from a magnetic stripe (not shown in FIGS. 7 and 8) of the card 720. The information read by the magnetic stripe reader 812 may be stored for subsequent retrieval by a malicious actor (e.g., the individual that installed the shimming device 810). FIG. 9 shows another block diagram of the card reader device 710 having a shimming device installed, shown as shimming device 910. As can be appreciated from FIG. 9, the shimming device 910 may be configured to lie between the card 720 and the card reader device 714, thereby enabling the shimming device 910 to read information from the EVM chip 722 when the card 720 is inserted into the card reader device 710, as described above. As shown in more detail below, embodiments of the present disclosure may enable the presence of the shimming device 910 to be detected externally.

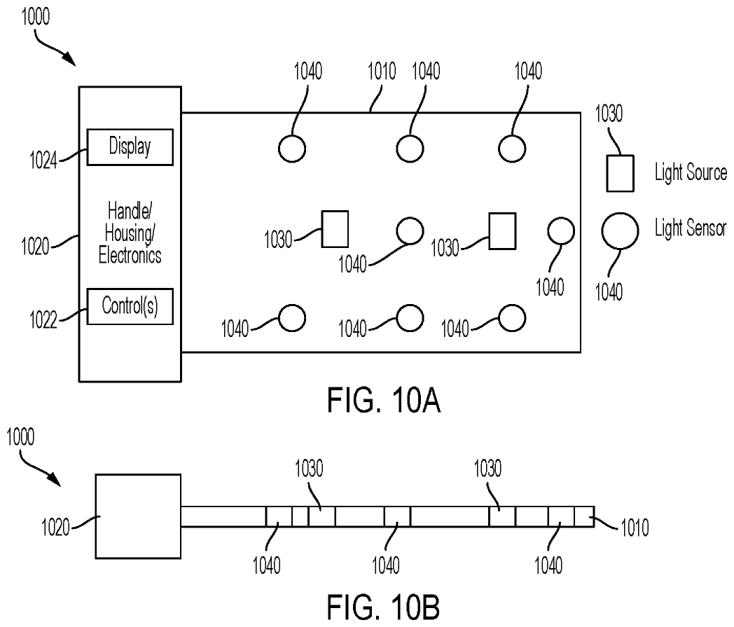

Referring to FIGS. 10A and 10B, block diagrams illustrating a top view and a side view of a shimming detection device in accordance with aspects of the present disclosure are shown as a shimming detection device 1000. As shown in FIGS. 10A and 10B, the shimming detection device 1000 may include a card 1010 and a handle 1020. Handle 1020 may enable a user to easily handle the shimming detection device 1000, such as to insert the card 1010 into the card reader device and subsequently retrieve the card 1010 once operations for scanning for the presence of a shimming device is complete. The handle 1020 may also serve as a housing that holds control circuitry and other electronics and components to facilitate scanning for shimming devices. For example, the handle 1020 may include one or more controls 1022 (e.g., buttons, switches, etc.) for initiating scanning, such as activating the light source(s) 1030 to cause the light sources to emit light, which may be detected by the light sensors 1040. The handle 1020 may also include one or more display devices 1024 that may be used to indicate whether a shimming device is detected (e.g., a green light when no shimming device is detected, a red light when a shimming device is detected, or other types of display devices). While FIG. 10B shows the handle 120 as including display device(s) 124, it should be understood that the handle 120 may utilize other techniques to provide feedback to a user regarding whether a shimming device is present in a particular terminal, such as audio feedback (e.g., a first sound to indicate no shimming device detected and a second sound to indicate a shimming device is detected) and/or communicating information to a remote device. The handle 1020 may also include a memory (e.g., for storing signature data, sensor data, instructions, etc.) and one or more processors (e.g., microcontrollers, CPUs, ASICs, etc.) for controlling operations of the shimming detection device 1000.

The card 1010 includes a one or more light sources 1030 and a plurality of light sensors 1040. In an aspect, the light sources 1030 may be infra-red (IR) light sources. In additional or alternative aspects, the light sources 1040 may be other types of light sources. It is noted that the light sources 1030 may also include multiple types of light sources (e.g., IR light sources and other types of light sources). The light sensors 1040 may include light sensors configured to detect one or more types of light emitted by the light sources 1030. In an aspect, the light sources 1030 and light sensors 1040 may be used to perform different types of testing at various points of the card 1010, where the different types of testing translate to different locations within internal space and geometry of the card reader device (e.g., the card reader device 710 of FIG. 7). One type of testing may involve ambient light or backscatter measurement, as described in more detail below. Another type of testing that may be utilized is proximity testing. During proximity testing a distance from the card 1010 to the roof of cavity of the card reader device may be measured. As described below with reference to the ambient light measurements, the distance measurements may be used to characterize what a clean (i.e., non-shimmed) card reader device looks like. The measurements captured for a clean card reader device may then be used to detect the presence of a foreign object (i.e., shimmer) in card reader devices, such as by comparing field measurements obtained from a card reader device to the measurements obtained from a clean card reader device.

It is noted that FIG. 10A shows 2 light sources 1030 and 8 light sensors 1040 for purposes of illustration, rather than by way of limitation and that shimming detection devices 1000 according to the present disclosure may include more than 2 light sources or less than 2 light sources and/or more than 8 light sensors or less than 8 light sensors in some configurations. It is also noted that since the shimming detection device 1000 is not used for transactions and is instead used to detect the presence of shimming devices, the shimming detection device 1000 may not include an EVM if desired, but may include one to simulate an actual card if desired. The light source(s) 1030 and light sensor(s) 1040 may be configured to facilitate optical shimmer detection (OSD). To facilitate detection of shimming devices using OSD, the shimming detection device 1000 may be utilized to analyze different types of non-shimmed card reader devices to obtain optical signatures or characteristics indicating what a “clean” (i.e., non-shimmed) card reader should look like. This may accomplished by characterizing a “clean” card reader under controlled conditions and storing information from the light sensor(s) 1040 as a reference or signature.

Using the OSD techniques disclosed herein enables shimming devices to be detected in card readers since all shimmers will disrupt light that is shined on them in some way (e.g., by the light source(s) 1030). For example, shimming devices may reflect, absorb, or prevent light from flowing as it would if the shimmer was not present. This means that the light signals detected by the light sensor(s) 1040 change, in some measurable way, when a shimming device is present. To illustrate, during detection of shimming devices, the signatures or characteristics of “clean” card readers may be utilized to detect that there is something in the card reader that should not be there, such as a shimming device. For example, it may be assumed that no foreign objects should ever be found inside a card reader and any optical signatures or characteristics (e.g., based on data from the light sensor(s) 1040) that deviate from the baseline signatures of the “clean” card readers may indicate the presence of a foreign object, such as a shimming device. Thus, to detect shimming devices using OSD, optical characteristics or signatures of a card reader in an unknown state (e.g., it is unknown if the card reader is “clean” or has a shimming device) may be compared against the expected “clean” state or signatures. If the comparison indicates a deviation from the “clean” state, the presence of a foreign object, which may be a shimming device, may be detected inside the card reader.

It is noted that the light sources 1040 and the light sensors 1030 may be arranged in particular locations to facilitate appropriate testing in accordance with the concepts disclosed herein in some embodiments. For example, the light sources 1040 may be centrally located with respect to the width of the card and/or the length of the card. Where multiple light sources 1030 are provided, at least one of the light sensors 1030 may be located near (e.g., within 1-5 centimeters (cm), 1-4 cm, 1-3 cm, 1-2 cm, 2-4 cm, or some other distance from) the position where the EMV chip is located in order to improve detection of a shimming device (e.g., using the distance measurement technique or another technique). The light sources 1030 may also include one or more light sources 1030 placed around the periphery of the card 1010 to enable backscatter or ambient light testing, described in more detail below, to detect the presence of shimmers that are not focused on EMV chip-skimming, such as magstripe shimming devices, embedded shimming devices, or other types of devices currently being used to attack ATMs and other card reader-enabled devices). The light sensors 1040 may be placed at different locations along the length and width of the card to provide sufficient locations for creating light profiles or signatures of clean card reader devices and to accommodate detection of foreign devices or objects in card reader devices during field testing (e.g., different types of shimming devices may produce different measurement and/or ambient light signatures or profiles and providing light sensors at various locations on the card 2020 may enable multi-point signatures or profiles to account for the impact that different shimming devices have on measurements and ambient light signatures).

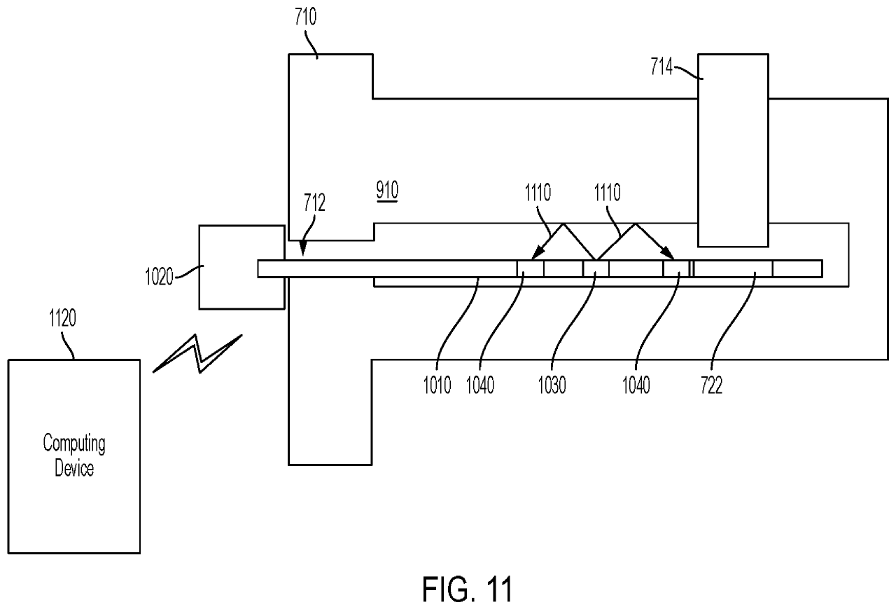

Referring to FIG. 11 is a block diagram illustrating detection of a shimming detection device using OSD techniques in accordance with aspects of the present disclosure is shown. As shown in FIG. 11, to facilitate detection of shimming devices using the shimming device 1000 of FIGS. 10A, 10B, the shimming detection device 1000 may be inserted into the slot 712 of a card reader device (e.g., the card reader device 710 of FIG. 7). Once inserted or during insertion, the light source(s) 1030 may emit light 1110. The light may illuminate the space within the card reader and be detected by the light sensor(s) 1040. The light sensor(s) 1040 may be configured to measure an amount of light received at a number of locations within the card reader (e.g., locations corresponding to the light sensors 1040 of FIG. 10A) or other light characteristics (e.g., intensity of the received light, etc.). As briefly described above, the shimming detection device 1000 may be used in a controlled environment to capture these measurements for different types of card reader devices to create “clean” light profiles or signatures (e.g., signatures that indicate the card reader device(s) does not contain a shimming device).

As shown in FIG. 11, in an aspect, the handle 1020 may include a communication interface that enables the shimming detection device 1000 to communicate with an external computing device 1120, such as a mobile device (e.g., a smartphone, a tablet computing device, a laptop computing device, etc.) or other type of device, to provide information regarding the light measurements obtained by the light sensors 1040. The light measurements may then be stored for different types of card reader devices to create a set of “clean” profiles for the different types of card reader devices analyzed in the controlled environment. In an aspect, the operations performed by the shimming detection device 1000 may be controlled via control signals provided from an external device, such as the computing device 1120, rather than requiring the control logic to be part of the shimming detection device 1000 itself. For example, the computing device 1120 may be configured to provide control signals to the shimming detection device 1000 that control operations of the shimming detection device 1000 (e.g., light emission patterns, sensor detection patterns, etc.), thereby enabling the shimming detection device 1000 to be produced with less computing resources and reducing the cost to produce the shimming detection device 1000.

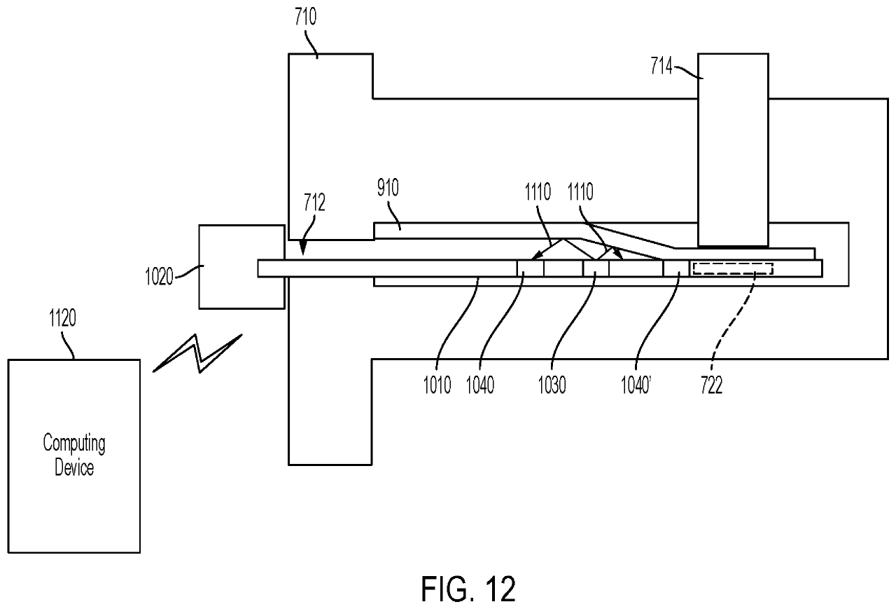

Referring to FIG. 12 is a block diagram illustrating a system for detecting a shimming device in accordance with aspects of the present disclosure. As described above, when a shimming device, such as the shimming device 910 of FIG. 9, is present in a card reader device the light characteristics measured by the light sensors 1040 may change. For example, in FIG. 12, the light sensor 1040′ located proximate to the position where the EVM chip 722 would be located may receive no light or less light than would otherwise be detected when the shimming device 910 is not present. As such, the characteristics of the light profile generated when the shimming device 910 is present may be different than the “clean” profile or signature for the card reader device when the shimming device 910 is not present. The shimming detection device 1000 may provide information regarding the light measurements to the computing device 1120 and the computing device 1120 may compare the light measurements to a “clean” profile for the card reader device to determine whether a shimming device is present.

In an aspect, testing of a card reader device for the presence of shimming devices may involve multiple test cycles. For example, the shimming detection device 1000 may include multiple light sources 1030, as shown in FIG. 10A, and different patterns of illuminating the interior space of the card reader using different combinations of the light sources 1030 may be performed and light measurements captured. Capturing light measurements using different combinations of light sources may enable structural and material differences between different types of shimming devices to be detected and may improve the overall accuracy of the shimming detection device 1000. For example, when a testing sequence is initiated to evaluate whether a card reader device has or has not been shimmed, a lighting sequence may be executed whereby different ones of the light sources 1030 are activated to illuminate the interior space of the card reader. As the light sources 1030 are activated each of the light sensors may record measurements of the light readings. Since different shimming devices may impact the light used to illuminate the interior region of the card reader in different ways, using multiple illumination patterns may enable more robust detection of shimming devices than if a single pattern was used.

In the particular example shown in FIG. 12, since the light sensor 1040′ may exhibit reduced light measurements (e.g., because it is blocked or at least partially blocked by the shimming device 910), the computing device 1120 may determine that the profile associated with the light measurements received from the shimming detection device 1000 deviates from the “clean” profile and may indicate to a user that the shimming device 910 is present. Additionally or alternatively, comparison of the light measurements to the “clean” profile may be performed by circuitry of the shimming detection device 1000 (e.g., circuitry in the handle 1020) and the presence of the shimming device 910 may be indicated via the display device(s) 1024 of FIG. 10B. It is noted that when the presence or absence of a shimming device within a card reader under test is provided via the display device(s) 1024 of the shimming detection device 1000, the light measurements may still be passed to the computing device 1120 (e.g., for purposes of storing the light measurements or other purposes). In additional or alternative aspects, the presence (or absence) of a shimming device within a card reader may be indicated on both the display device(s) 1024 and the computing device 1120.

As an illustrative example of the concepts described above with reference to FIGS. 11 and 12, suppose that during testing of the card reader device of FIG. 11, which does not include a shimming device, the two light sensors 1040 shown in FIG. 11 obtain measurements of “X” and “Y”, respectively, when the light source 1030 is activated. The measurements “X” and “Y” may be stored as a baseline or signature of the card reader (e.g., a “clean” profile or signature). When the shimming detection device is inserted into the card reader device shown in FIG. 12 the measurements obtained from the light sensors may be altered due to the presence of the shimming device 910. For example, the measurements may be “X” and “Z”, where “Z” is different than “Y”, or may be “W” and “Z”, where “W” is different from “X” and “Z” is different than “Y”, due to the impact of the shimming device 910 on the light emitted from the light source 1030. Based on comparing the “clean” signature generated in FIG. 11 to the measurements obtained in FIG. 12 it may be determined that a shimming device is present.

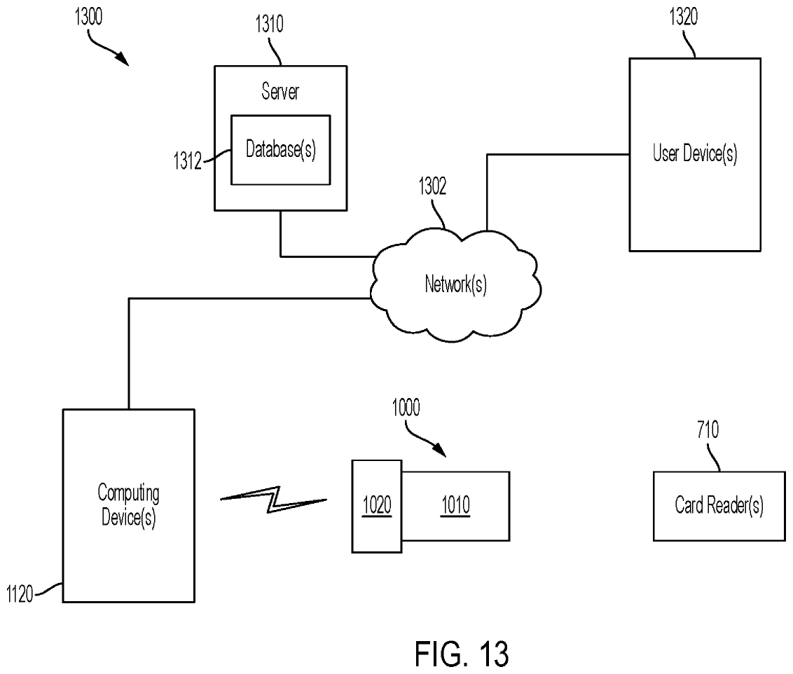

Referring to FIG. 13, a block diagram illustrating a system for detecting a shimming device in accordance with aspects of the present disclosure is shown as a system 1300. As shown in FIG. 13, the system 1300 may include one or more shimming detection devices 1000, one or more computing devices 1120, and one or more servers 1310. As described above, the one or more shimming detection devices 1000 may be used to analyze card reader devices 710 to evaluate whether shimming devices are present. Information captured by the shimming detection devices 1000 may be provided to the computing device(s) 1120, which may be devices used by an individual responsible for testing the card reader devices 710 for the presence of shimming devices.

The computing device(s) 1120 may be communicatively coupled to the server 1320 via one or more networks 1302 and may provide information associated with testing of card reader devices to the server 1320. The server 1320 may be configured to store the information provided by the computing device(s) 1120 at one or more databases 1312. Over time, the information stored at the database(s) 1312 may be used to create signatures or profiles of known shimming devices based on light measurements obtained by the shimming detection devices 1000, thereby improving the accuracy with respect to detection of shimming devices. For example, signatures of different shimming devices may be generated over time, thereby enabling detection of shimming devices based on their light signatures, rather than just based on deviation from “clean” signatures. This may provide a higher level of granularity with respect to detection of shimming devices and minimize false positives (e.g., if debris or other non-shimming devices somehow get inside a card reader device).

In an aspect, “clean” signatures or profiles may be initially stored at the database(s) 1312 (e.g., a “clean” signature database), such as in the above-describe process for initializing profiles for different card reader devices. The “clean” signatures may subsequently be provided to different computing devices 1120 that may then be used to load the signatures to a memory of the shimming detection devices 1000. In an aspect, the signatures may be loaded onto the shimming detection devices 1000 in a different manner, such as via the server 1310 or another technique. Other types of data may also be exchanged between the server 1310, the computing device(s) 1120, and the shimming detection devices 1000 (e.g., illumination patterns for activating the light sensors 1030 and/or detecting light at different ones of the light sensors 1040 of FIG. 10, signatures of known shimming devices, such as measurements or ambient light levels, and the like) in order to facilitate efficient operation of the system 1300 and the concepts disclosed herein.

In an aspect, the server 1310 and/or the computing device(s) 1120 may also communicate information regarding the detection of shimming devices in the card reader devices 710 to user devices 1320. For example, the user devices 1320 may be associated with individuals that operate places of business where the card readers 710 are located or maintain the card reader devices 710. When a shimming device is detected, a message may be transmitted to the user device(s) 1320 to indicate the detection of a shimming device. The individual associated with the user device 1320 may then perform or schedule maintenance to have the shimming device removed. Additionally, messages may be transmitted to the user device(s) 1320 to indicate that no shimming devices were detected. In an aspect, when a shimming device is detected using the techniques described herein, the computing device 1120, the server 1310, or another device may transmit a signal to the terminal in which the shimmed card reader device is located to turn off or deactivate the card reader device, thereby preventing the shimming device from being used to capture additional information from user cards.

In an aspect, information regarding the scanning of the card reader devices 710 for the presence of shimming devices may be maintained in the one or more databases 1312. For example, each time that a card reader device 710 is scanned for shimming devices using the shimming detection device 1000, a record may be recorded to the database(s) 1312 that indicates the result of the scan. The records of the database may include timestamps for each scan, as well as location information regarding the location of each scanned card reader device. Such a database may provide a historical record of the presence of shimming devices (or lack thereof) with respect to the card reader devices 710. In an aspect, the information stored in the records of the database may enable locations of card reader devices where shimming devices have been detected or determined to not be present to be displayed via a graphical user interface, such as on a map. The map may be accessible to members of the general public (e.g., via an application running on a mobile device or via a website) to enable individuals to view information regarding whether a shimming device has been detected at a card reader device (e.g., a card reader device at a location where the user is going to conduct a transaction). This may enable the individuals to avoid using card reader devices known to be targets of shimming devices and identify card reader devices that have been scanned for shimming devices recently, thereby reducing the risk that the individuals card information is obtained by a shimming device.

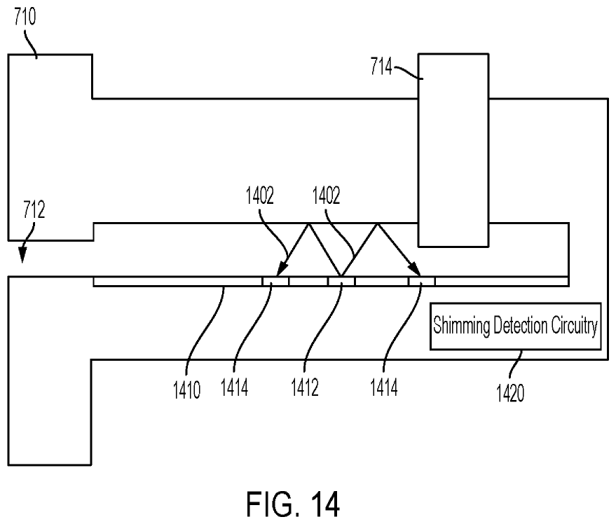

Referring to FIG. 14, a block diagram illustrating a system for detecting a shimming device in accordance with aspects of the present disclosure is shown. In the embodiment shown in FIG. 14, the card reader device 710 of FIG. 7 is shown and includes an integrated shimmer detection device. The integrated shimmer detection device includes an sensor array 1410 having one or more light sources 1412 and one or more light sensors 1414. The light source(s) 1412 may be the same as the light sources 1030 of FIG. 10 and the light sensors 1414 may be the same as the light sensors 1040 of FIG. 10. Additionally, the integrated shimmer detection device may include a shimming detection circuit 1420. The shimming detection 1420 may be configured to control emission of light by the light source(s) 1412 and to receive measurements from the light sensors 1414. This may enable the integrated shimmer detection device to monitor the card reader device 710 for shimming devices automatically and more frequently than using the shimming detection device 1000 of FIGS. 10A and 10B, which may enable detection of shimming devices when they are installed or shortly thereafter. For example, the shimming detection circuit 1420 may periodically (e.g., once every 15 minutes, hour, 4 hours, etc.) provide a control signal to the light source(s) 1412 to cause the light sources 1412 to emit light that may be detected by the light sensors 1414. The measurements detected by the light sensors 1414 may be provided to the shimming detection circuit 1420 and compared to a baseline or “clean” profile of the card reader device 710 to determine whether a shimming device is present.

It is noted that the light measurements may be impacted if a card is inserted to the card reader device 710 during the measurement process. To address this situation, the shimming detection circuit 1420 may be configured to initiate a subsequent scanning process when a potential shimming device is detected, such as 30 seconds later. If the prior scan indicating the potential presence of a shimming device was the result of a card being inserted to the card reader device 710, as opposed to a shimming device, the subsequent scan may return measurements that are similar to the “clean” profile and no shimming device may be detected. However, the presence of a shimming device may be confirmed if the subsequent scan again returns measurements indicating the presence of a shimming device. It is noted that other techniques may additionally or alternatively be used to confirm the presence of a shimming device and that the techniques described above has been provided for purposes of illustration, rather than by way of limitation. It is also noted that the integrated shimming detection device of FIG. 14 may also be utilized in the system 1300 of FIG. 13. For example, the integrated shimming detection device may include a communication interface that communicatively coupled the integrated shimming detection device to the server 1320 and the integrated shimming detection device may be configured to periodically provide information regarding scans performed by the integrated shimming detection device to the server 1320, as described above with reference to FIG. 13.

If a shimming device is detected by the shimming detection circuitry 1420, a control signal may be provided to the card reader device 710 to disable the EVM chip reader 714, thereby placing the card reader device 710 in a non-operative state. In addition to the control signal to disable the card reader device 710, an audible alarm may sound and/or a message may be transmitted to an individual associated with the card reader device 710, such as an operator of a store where the card reader device 710 is located or an entity responsible for maintaining the card reader device 710.

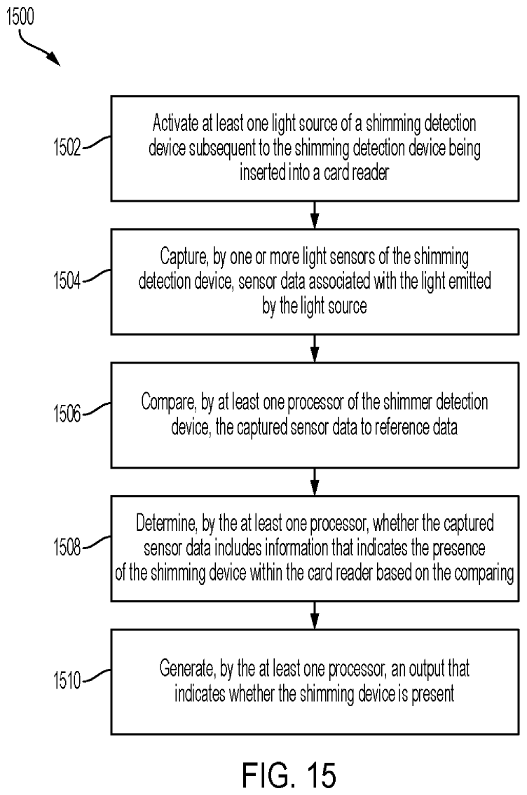

Referring to FIG. 15, a flow diagram of a method for detecting a shimming device in accordance with aspects of the present disclosure is shown as a method 1500. In an aspect, steps of the method 1500 may be stored as instructions that, when executed by one or more processors, cause the one or more processors to perform the method 1500. In an aspect, the method 1500 may be performed by circuitry of a shimming detection device (e.g., circuitry of the shimming detection device 1000 of FIGS. 10A and 10B or the shimming detection circuitry 1420 of FIG. 14), by a computing device (e.g., the computing device 1120 of FIG. 11), or another device adapted to perform operations of the method 1500.

At step 1502, the method 1500 includes activating at least one light source of a shimming detection device subsequent to the shimming detection device being inserted into a card reader. The shimming detection device may be the shimming detection device 1000 of FIGS. 10A and 10B or may be the integrated shimming detection device of FIG. 14. At step 1504, the method 1500 includes capturing, by one or more light sensors of the shimming detection device, sensor data associated with the light emitted by the light source. At step 1506, the method 1500 includes comparing, by at least one processor of the shimmer detection device, the captured sensor data to reference data. As described above, the reference data used in the comparing may be a “clean” profile or signature of the card reader.

At step 1508, the method 1500 includes determining, by the at least one processor, whether the captured sensor data includes information that indicates the presence of the shimming device within the card reader based on the comparing. As described above, the presence of the shimming device may be detected when the sensor data (e.g., light measurements obtained by the light sensors) deviates from the reference data. In some aspects, multiple samples of the sensor data may be captured (e.g., using different combinations of light sources, etc.), as described above. At step 1510, the method 1500 includes generating, by the at least one processor, an output that indicates whether the shimming device is present. As described above, the output may be a light, an audible alert, a message displayed on a computing device (e.g., the computing device 1120 of FIG. 11), or another type of output.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

1. A method for detecting a shimming device, the method comprising:
capturing, by one or more sensors of a shimmer detection device, in response to the shimmer detection device being inserted into a card reader, sensor data associated with a presence of the shimming device within the card reader;
comparing, by at least one processor of the shimmer detection device, the captured sensor data to reference data;
determining, by the at least one processor, whether the captured sensor data includes information that indicates the presence of the shimming device within the card reader based on the comparing; and
generating, by the at least one processor, an output that indicates whether the shimming device is present.

2. The method of claim 1, further comprising:
activating, by the at least one processor, the one or more sensors subsequent to the shimmer detection device being inserted into the card reader.

3. The method of claim 1, wherein comparing the captured sensor data to reference data includes:
obtaining a signature included in the reference data, the signature associated with sensor data captured from a card reader known to be compromised with a shimmer;
determining whether the captured sensor data matches the signature.

4. The method of claim 1, wherein the one or more sensors comprise at least one sensor selected from the list consisting of: a Bluetooth sensor, an infrared sensor, a magnetometer, a radio frequency (RF) transceiver, an analog sensor, and a card sleeve.

5. The method of claim 4, wherein determining whether the captured sensor data includes information that indicates the presence of the shimming device within the card reader based on the comparing includes:
measuring, by the analog sensor, a resistance subsequent to the shimmer detection device being inserted into the card reader;
comparing the measured resistance to an expected resistance, the expected resistance being a resistance expected when the shimmer detection device is inserted into a shimmerless card reader; and
determining that the shimming device is present within the card reader when the measured resistance is different from the expected resistance.

6. The method of claim 4, wherein the one or more sensors includes the card sleeve, the card sleeve configured with at least one contact slot configured to allow at least one read head blade of the card reader to pass through when the at least contact slot is disposed under the at least one read head blade.

7. The method of claim 6, further comprising:
inserting the shimmer detection device into the card sleeve prior to the shimmer detection device being inserted into the card reader;
determining, subsequent to the shimmer detection device being inserted into a card reader, whether the at least one read head blade of the card reader is in communicative contact with the shimmer detection device;
determining that the shimming device is present within the card reader when the at least one read head blade of the card reader is determined to be communicatively disconnected from the shimmer detection device; and
determining that the shimming device is not present within the card reader when the at least one read head blade of the card reader is determined to be in communicative contact with the shimmer detection device.

8. The method of claim 1, further comprising determining a confidence level regarding the presence of the shimming device, wherein the output that indicates whether the shimming device is present includes the confidence level.

9. The method of claim 8, wherein the confidence level is presented in the output as a color coded indicator including different colors that correspond to different confidence levels.

10. The method of claim 9, wherein the confidence level is one selected from the group consisting of: a shimming device is not detected, a shimming device is likely detected, and a shimming device is confirmed detected.

11. A system for detecting a shimming device, the system comprising:
a shimmer detection device comprising:
one or more sensors configured to capture sensor data subsequent to the shimmer detection device being inserted into a card reader;
at least one processor configured to:
compare the captured sensor data to reference data;
determine the shimming device is present within the card reader based on comparison of the captured sensor data to the reference data; and
generate an output that indicates whether the shimming device is present.

12. The system of claim 11, further comprising:
a sleeve configured to receive the shimmer detection device, the sleeve comprising at least one contact slot configured to receive at least one read head blade of the card reader when sleeve is inserted into the card reader such that the at least contact slot is disposed under the at least one read head blade.

13. The system of claim 12, wherein the shimmer detection device is inserted into the sleeve prior to the shimmer detection device being inserted into the card reader, and wherein the captured sensor data comprises information indicating whether the at least one read head blade of the card reader is in communicative contact with the shimmer detection device.

14. The system of claim 11, wherein the one or more processors are configured to activate the one or more sensors subsequent to the shimmer detection device being inserted into the card reader.

15. The system of claim 11, wherein comparing the captured sensor data to reference data includes:
obtaining a signature included in the reference data, the signature associated with sensor data captured from a card reader known to be compromised with a shimmer;
determining whether the captured sensor data matches the signature.

16. The system of claim 11, wherein the one or more sensors comprise at least one sensor selected from the list consisting of: a Bluetooth sensor, an infrared sensor, a magnetometer, a radio frequency (RF) transceiver, an analog sensor, and a card sleeve.

17. The system of claim 11, wherein determining whether the captured sensor data includes information that indicates the presence of the shimming device within the card reader based on the comparing includes:
measuring, by the analog sensor, a resistance subsequent to the shimmer detection device being inserted into the card reader;
comparing the measured resistance to an expected resistance, the expected resistance being a resistance expected when the shimmer detection device is inserted into a shimmerless card reader; and
determining that the shimming device is present within the card reader when the measured resistance is different from the expected resistance.

18. A method for detecting a shimming device, the method comprising:
activating at least one light source of a shimming detection device subsequent to the shimming detection device being inserted into a card reader;
capturing, by one or more light sensors of the shimming detection device, sensor data associated with the light emitted by the light source;
comparing, by at least one processor of the shimmer detection device, the captured sensor data to reference data;
determining, by the at least one processor, whether the captured sensor data includes information that indicates the presence of the shimming device within the card reader based on the comparing; and
generating, by the at least one processor, an output that indicates whether the shimming device is present.

19. The method of claim 18, wherein the shimming detection device comprises a card and a handle.

20. The method of claim 19, wherein the at least one light source and the one or more light sensors are disposed on the card.

21. The method of claim 19, wherein the output comprises a visual indicator displayed on a display device disposed in the handle.

22. The method of claim 19, further comprising transmitting the output to an external computing device.

23. The method of claim 18, wherein the shimming detection device is integrated with the card reader.

24. The method of claim 18, wherein the at least one light source comprises at least a first light source and a second light source, and wherein the activating comprises:
activating the first light source for a first period of time, wherein a first portion of the captured sensor data is captured during the first period of time; and
activating the second light source for a second period of time, wherein a second portion of the captured sensor data is captured during the second period of time.

25. The method of claim 24, wherein the second period of time and the first period of time are non-overlapping periods of time.

26. The method of claim 24, further comprising, activating the first light source and the second light source at least partially simultaneously for a third period of time, wherein a third portion of the captured sensor data is captured during the third period of time.

27. The method of claim 18, further comprising confirming the presence of the shimming device based on subsequent activation of the at least one light source and capturing additional sensor data during the subsequent activating.

28. A system for detecting a shimming device, the system comprising:
a shimming detection device comprising:
at least one light source; and
one or more light sensors; and
one or more processors configured to:
activate the at least one light source subsequent to the shimming detection device being inserted into a card reader;
receive sensor data captured by the one or more light sensors, wherein the sensor data is associated with the light emitted by the light source;
compare the captured sensor data to reference data;
determine whether the captured sensor data includes information that indicates the presence of the shimming device within the card reader based on the comparing; and
generate an output that indicates whether the shimming device is present.

29. The system of claim 28, wherein the shimming detection device comprises:
one or more controls configured to control activation of the at least one light source;
a card, wherein the at least one light source and the one or more light sensors are disposed on the card; and
a handle, wherein the one or more processors are disposed within the handle, and wherein the one or more controls are positioned on the handle.

30. The system of claim 28, further comprising a communication interface configured to transmit the output to an external computing device, the communication interface disposed within the handle.

31. The system of claim 28, further comprising a display device disposed on the handle, wherein the output comprises a visual indicator displayed on the display device.

32. The system of claim 28, further comprising confirming the presence of the shimming device based on subsequent activation of the at least one light source and capturing additional sensor data during the subsequent activating.

33. The system of claim 28, further comprising a card reader, wherein the shimming detection device is integrated with the card reader.

34. The system of claim 33, further comprising control circuitry configured to disable the card reader in response to detection of a shimmer device.

35. The system of claim 33, further comprising control circuitry configured to transmit an alert to a user in response to detection of a shimmer device.

36. The system of claim 28, wherein the at least one light source comprises at least a first light source and a second light source, and wherein activating the at least one light source comprises:
activating the first light source for a first period of time, wherein a first portion of the captured sensor data is captured during the first period of time; and
activating the second light source for a second period of time, wherein a second portion of the captured sensor data is captured during the second period of time.

37. The system of claim 36, wherein the second period of time and the first period of time are non-overlapping periods of time.

38. The system of claim 36, wherein the second period of time and the first period of time are at least partially simultaneous periods of time.

39. The system of claim 28, further comprising a memory storing one or more light source activation sequences for controlling activation of the at least one light source.

40. The system of claim 39, wherein the memory stores one or more signatures corresponding to sensor data captured by the one or more light sources.

41. The system of claim 40, wherein the one or more signatures comprise signatures corresponding to sensor data associated with different shimming devices.

42. The system of claim 39, wherein the one or more signatures comprise signatures corresponding to sensor data associated with at least one clean card reader.
